(19) United States
(12) Patent Application Publication
(10) Pub. No.: US 2005/0223821 A1
(43) Pub. Date: Oct. 13, 2005

(54) Sampling system

(76) Inventor: Andreas Manz, Surrey (GB)

Correspondence Address: NIXON & VANDERHYE, PC, 901 NORTH GLEBE ROAD, 11TH FLOOR, ARLINGTON, VA, 22203, US

(21) Appl. No.: 10/296,585

(22) PCT Filed: May 25, 2001
(86) PCT No.: PCT/GB01/02359

§ 371 Date: Mar. 25, 2003

(30) Foreign Application Priority Data
May 26, 2000 (GB) 0013000.5

(51) Int. Cl. G01N 1/22; G01N 30/20

(52) U.S. Cl. 73/864.33; 73/863.02; 73/23.41; 73/863.71

(57) ABSTRACT

A sampling system for and a method of separating a volume from a flow of a gaseous sample, the sampling system comprising: a first flow channel; a second flow channel intersecting the first flow channel; a first port in the first flow channel on one side of the point of intersection of the first and second flow channels through which a flow of a gaseous sample is in use delivered; a second port in the second flow channel on one side of the point of intersection of the first and second flow channels through which a flow of a carrier gas is in use delivered; a third port in one of the first and second flow channels on the other side of the point of intersection of the first and second flow channels through which a volume, as a sample plug, separated from the gaseous sample flow is in use driven; a fourth port in the other of the first and second flow channels to which a principal flow of the gaseous sample is in use directed; and a control unit to control the flow of the carrier gas delivered to the second port such as to separate a volume, as a sample plug, from the gaseous sample flow.

The present invention relates to a sampling system, preferably as a microfabricated chip-based unit, for and a method of separating a volume, as a sample plug, from a flow of a gaseous sample, and to a measurement system incorporating the sampling system. In particular, the present invention relates to a sampling system for and a method of separating a volume, as a sample plug, from a flow of a gaseous sample for delivery to the separation column of a measurement system such as a gas chromatograph. In the context of the present invention the term gaseous sample is to be understood as encompassing gases and supercritical fluids.

Precisely metered volumes of fluid samples, typically very small volumes of up to 2 μl, are required by many measurement systems, such as gas and liquid chromatographs, for accurate sample analysis.

Microsyringes are commonly used to deliver metered volumes of fluid samples, either as gases or liquids. These syringes, however, have a limited volumetric accuracy, and as such are not suited to the delivery of very small volumes.

Minaturized chip-based sampling systems have been proposed, but these systems are complex and require moving components to valve and meter a fluid sample. As will be appreciated, the fabrication of systems including such minaturized components is particularly difficult, and in requiring moving parts can suffer from problems of reliability.

It is thus an aim of the present invention to provide an improved sampling system, preferably as a microfabricated chip-based sampling unit, for separating a small volume, as a sample plug, from a flow of a gaseous sample, and in particular a sampling system which requires no moving parts. It is also an aim of the present invention to provide an improved sampling method.

Accordingly, the present invention provides a sampling system for separating a volume, as a sample plug, from a flow of a gaseous sample, comprising: a first flow channel; a second flow channel intersecting the first flow channel; a first port in the first flow channel on one side of the point of intersection of the first and second flow channels through which a flow of a gaseous sample is in use delivered; a second port in the second flow channel on one side of the point of intersection of the first and second flow channels through which a flow of a carrier gas is in use delivered; a third port in one of the first and second flow channels on the other side of the point of intersection of the first and second flow channels through which a volume, as a sample plug, separated from the gaseous sample flow is in use driven; a fourth port in the other of the first and second flow channels on the other side of the point of intersection of the first and second flow channels to which a principal flow of the gaseous sample is in use directed; and a control unit operably configured to control the flow of the carrier gas delivered to the second port such as to separate a volume, as a sample plug, from the gaseous sample flow.

In one embodiment the third port is in the first flow channel and the fourth port is in the second flow channel, and the control unit is configured to interrupt the flow of the carrier gas to the second port to separate a volume, as a sample plug, from the gaseous sample flow.

Preferably, the control unit is configured to interrupt the flow of the carrier gas to the second port for a predetermined period of time, with the period of interruption determining the volume of the separated sample plug for a given flow rate.

In another embodiment the third port is in the second flow channel and the fourth port is in the first flow channel, and the control unit is configured to deliver a high flow of the carrier gas to the second port to separate a volume, as a sample plug, from the gaseous sample flow.

Preferably, the sampling system further comprises a fifth port in the second flow channel on the other side of the point of intersection of the first and second flow channels through which a further flow of the carrier gas is in use delivered, wherein the control unit is configured in a first state to deliver the first and further flows of the carrier gas through the respective ones of the second and fifth ports and in a second, sampling state to deliver a high flow of the carrier gas to the second port to separate a volume, as a sample plug, from the gaseous sample flow.

Preferably, the first and second flow channels intersect one another substantially orthogonally.

In one embodiment the first flow channel includes first and second sections connected at a single point along the length of the second flow channel.

In another embodiment the first flow channel includes first and second sections connected at respective ones of spaced points along the length of the second flow channel.

Preferably, the sampling system further comprises a substrate chip in which the flow channels and the ports are defined.

The present invention also extends to a measurement system incorporating the above-described sampling system.

The present invention also provides a method of separating a volume, as a sample plug, from a flow of a gaseous sample, comprising the steps of: providing a sampling system comprising a first flow channel, a second flow channel intersecting the first flow channel, a first port in the first flow channel on one side of the point of intersection of the first and second flow channels, a second port in the second flow channel on one side of the point of intersection of the first and second flow channels, a third port in one of the first and second flow channels on the other side of the point of intersection of the first and second flow channels, and a fourth port in the other of the first and second flow channels on the other side of the point of intersection of the first and second flow channels; flowing a gaseous sample from the first port to the fourth port; and applying a flow of a carrier gas to the second port such as to separate a volume, as a sample plug, from the gaseous sample flow and drive the separated sample plug to the third port.

In one embodiment the third port is in the first flow channel and the fourth port is in the second flow channel, and a flow of the carrier gas to the second port is interrupted to separate a volume, as a sample plug, from the gaseous sample flow.

Preferably, the flow of the carrier gas is interrupted for a predetermined period of time, with the period of interruption determining the volume of the sample plug for a given flow rate.

In another embodiment the third port is in the second flow channel and the fourth port is in the first flow channel, and a high flow of the carrier gas is delivered to the second port to separate a volume, as a sample plug, from the gaseous sample flow.

Preferably, the sampling system further comprises a fifth port in the second flow channel on the other side of the point of intersection of the first and second flow channels, and the sampling method further comprises the step of applying a flow of the carrier gas to the fifth port, first and further substantially similar flows of the carrier gas being delivered in a first state through the respective ones of the second and fifth ports and in a second, sampling state a high flow of the carrier gas being delivered to the second port to separate a volume, as a sample plug, from the gaseous sample flow.

Preferably, the first and second flow channels intersect one another substantially orthogonally.

In one embodiment the first flow channel includes first and second sections connected at a single point along the length of the second flow channel.

In another embodiment the first flow channel includes first and second sections connected at respective ones of spaced points along the length of the second flow channel.

Preferably, the sampling system further comprises a substrate chip in which the flow channels and the ports are defined.

Preferably, the carrier gas is an inert gas.

Preferred embodiments of the present invention will now be described hereinbelow by way of example only with reference to the accompanying drawings, in which:

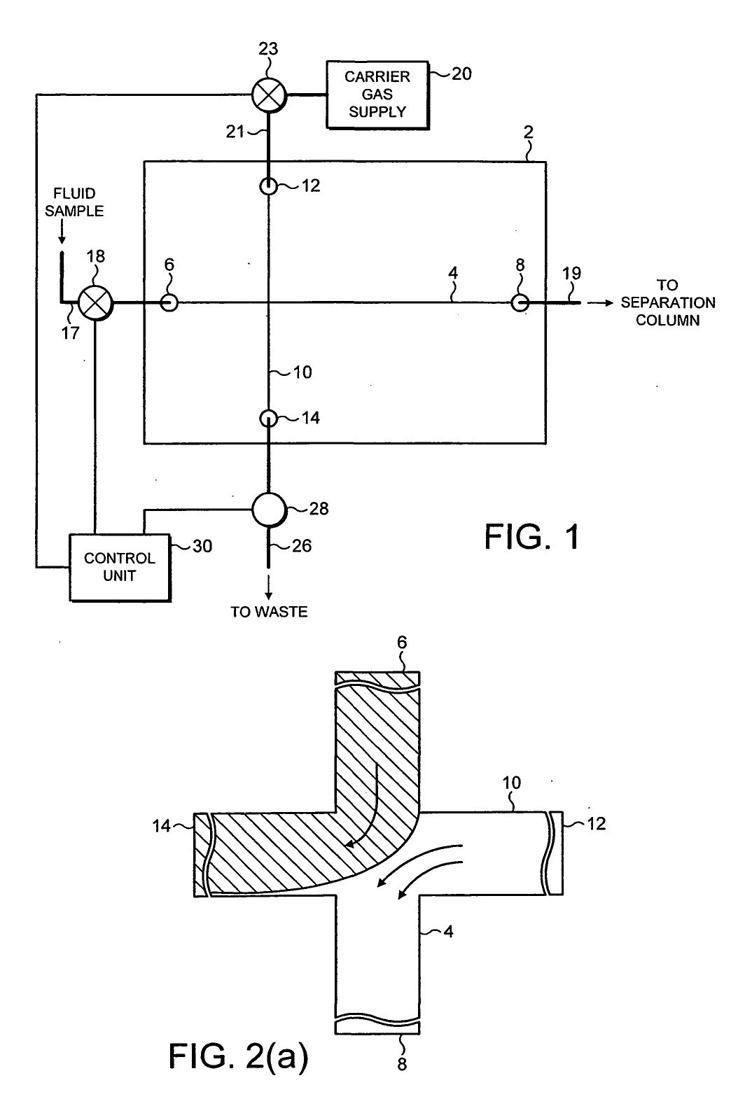

FIG. 1 schematically illustrates a microfabricated chip-based sampling system in accordance with a first embodiment of the present invention;

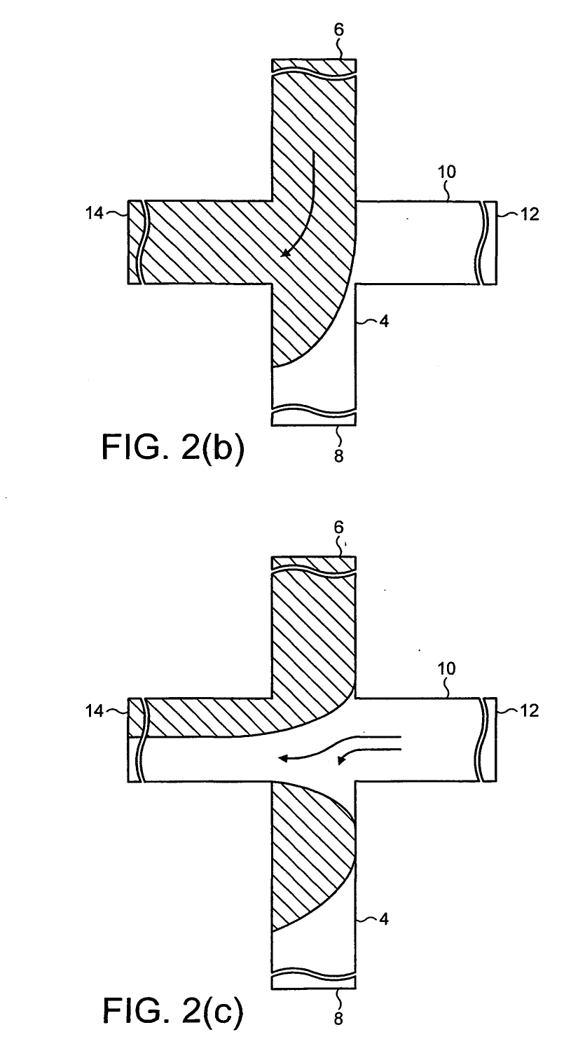

FIGS. 2(a) to (c) schematically illustrate the operation of the sampling system of FIG. 1;

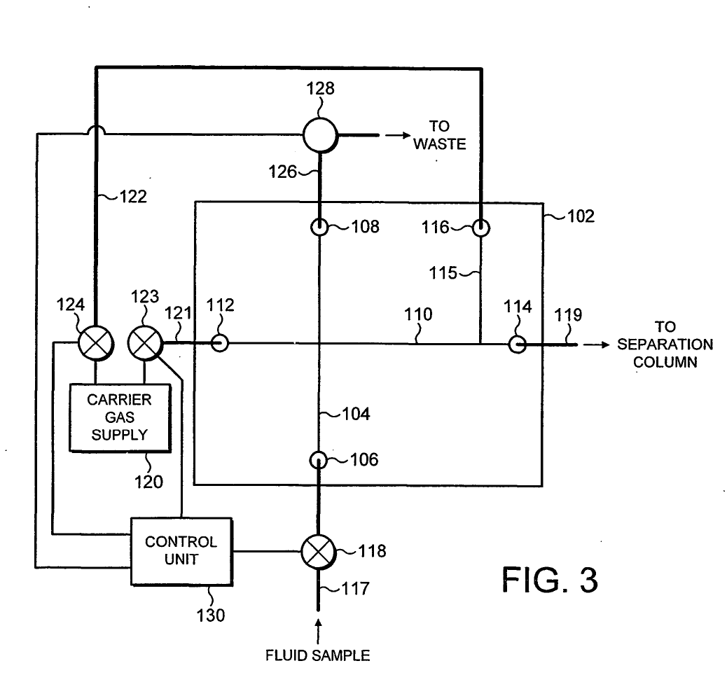

FIG. 3 schematically illustrates a microfabricated chip-based sampling system in accordance with a second embodiment of the present invention;

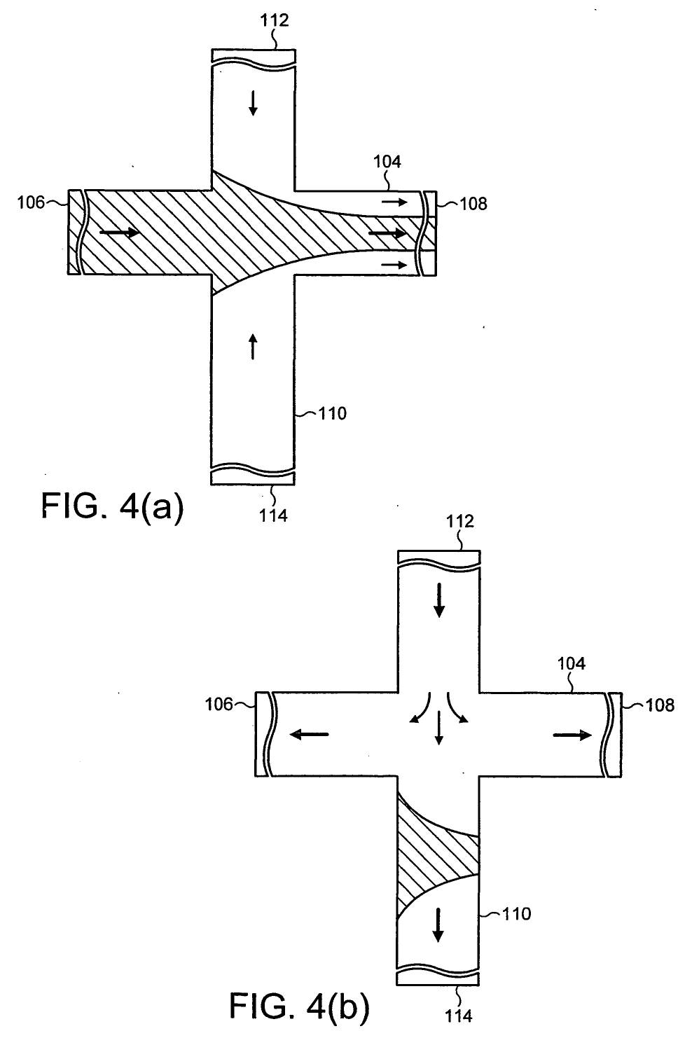

FIGS. 4(a) and (b) schematically illustrate the operation of the sampling system of FIG. 3;

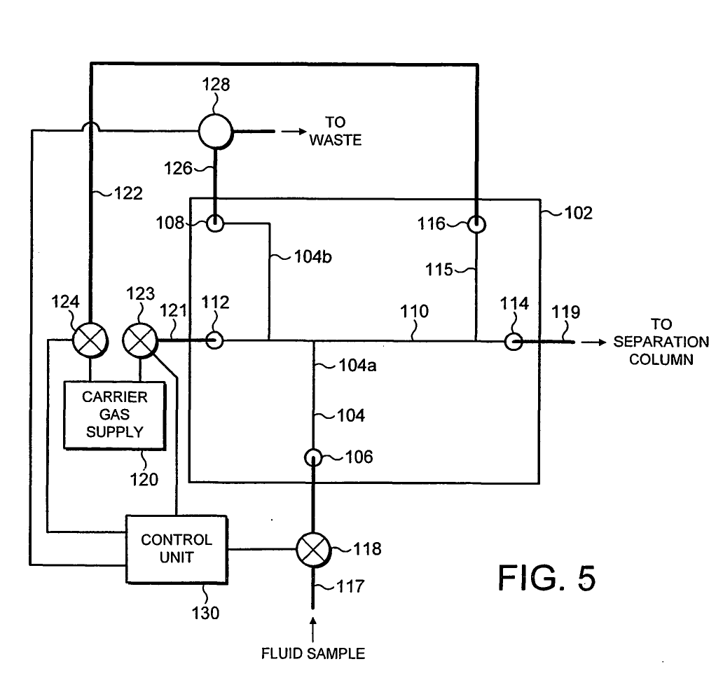

FIG. 5 schematically illustrates a microfabricated chip-based sampling system in accordance with a third embodiment of the present invention;

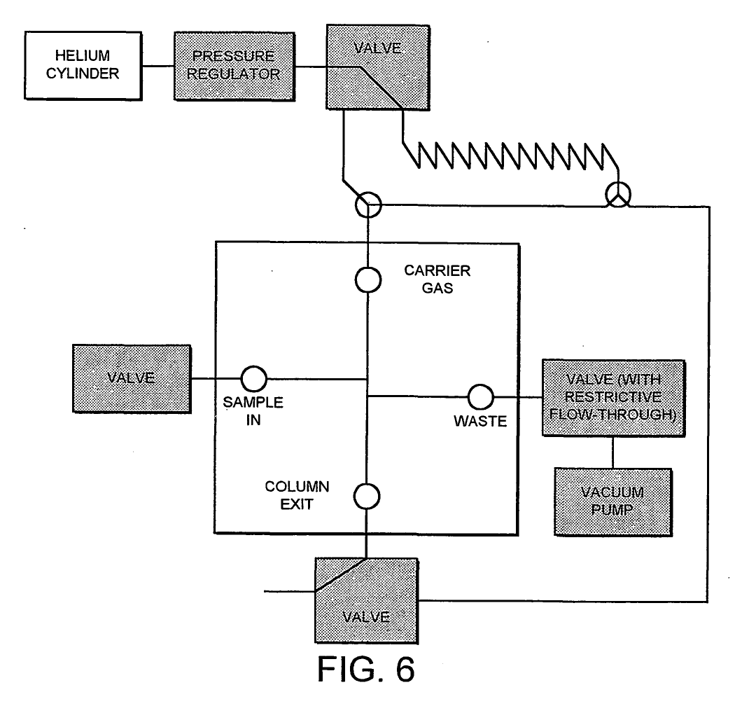

FIG. 6 schematically illustrates a further embodiment of a microfabricated chip-based sampling system in accordance with another example; and

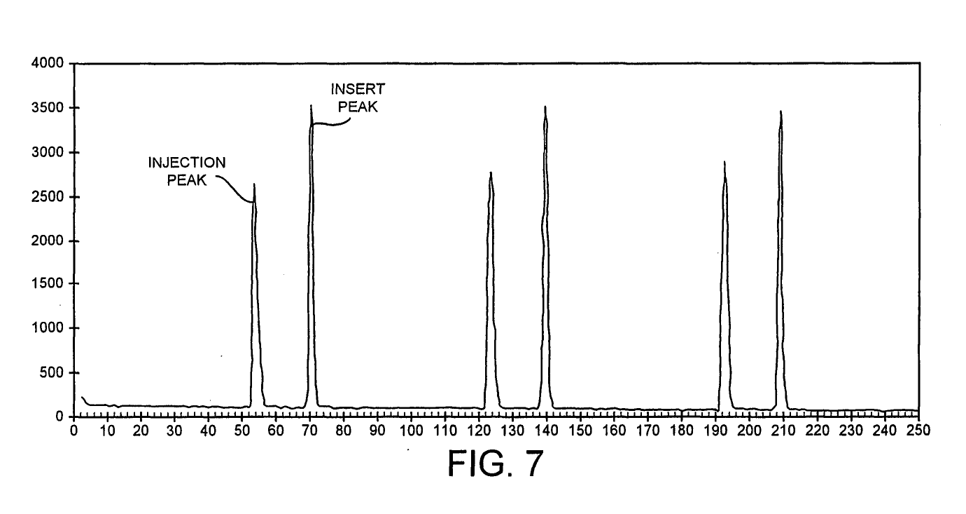

FIG. 7 illustrates spectral samples varying with time illustrating the forming of gas samples using the system of FIG. 6.

FIG. 1 illustrates a sampling system in accordance with a first embodiment of the present invention.

The sampling system comprises a microfabricated substrate chip 2 which includes a first channel 4, in this embodiment a linear channel, which includes first and second ports 6, 8, and a second channel 10, in this embodiment a linear channel, which intersects the first channel 4 and includes first and second ports 12, 14. In an alternative embodiment the first and second channels 4, 10 can be meandering channels which preferably include a plurality of bends. Preferably, the first and second channels 4, 10 each have a width of from about 50 to 300 μm and a depth of from about 10 to 40 μm.

The chip 2 is fabricated from two plates, which, in this embodiment, are composed of microsheet glass. In a first step, one of the plates is etched by HF wet etching to form wells which define the first and second channels 4, 10, with the wells having the dimensions mentioned above. In a second step, four holes are drilled, in this embodiment by ultrasonic vibration, into the other plate so as to provide the ports 6, 8 of the first channel 4 and the ports 12, 14 of the second channel 10. In a third and final step, the two plates are bonded together by direct fusion bonding.

The sampling system further comprises a sample delivery line 17 which includes a metering valve 18 and is connected to the first port 6 of the first channel 4, in this embodiment by a Swagelok™ connector to a fused silica capillary tube bonded to the chip 2, through which a controlled flow of a gaseous sample is in use introduced.

The sampling system further comprises a sample plug supply line 19 which is connected to the second port 8 of the first channel 4, in this embodiment by a Swagelok™ connector to a fused silica capillary tube bonded to the chip 2, through which a metered volume of the gaseous sample, as a sample plug, is in use fed to the separation column of a measurement system.

The sampling system further comprises a carrier gas supply Unit which comprises a carrier gas supply 20, in this embodiment a pressurised gas source, and a carrier gas delivery line 21 which includes a metering valve 23 and connects the carrier gas supply 20 to the first port 12 of the second channel 10, in this embodiment by a Swagelok™ connector to a fused silica capillary tube bonded to the chip 2, through which a controlled flow of a carrier gas is in use delivered. In this embodiment the carrier gas is an inert gas such as helium.

The sampling system further comprises a waste line 26 which includes a vacuum pump 28 and is connected to the second port 14 of the second channel 10, in this embodiment by a Swagelok™ connector to a fused silica capillary tube bonded to the chip 2, through which flows of the gaseous sample and the carrier gas are selectively fed from the chip 2. In this embodiment the vacuum pump 28 is provided to maintain a reduced pressure in the downstream section of the second channel 10 relative to the pressure in the downstream section of the first channel 4. In an alternative embodiment, however, the vacuum pump 28 could be omitted and instead the shape and/or dimension of the downstream sections of the first and second channels 4, 10 configured such that, for a given pressure of the delivered flow of the carrier gas, the pressure in the downstream section of the second channel 10 is sufficiently lower than the pressure in the downstream section of the first channel 4 as to cause the flow of the gaseous sample to be directed to waste through the downstream section of the second channel 10.

The sampling system further comprises a control unit 30 which is connected to the valve 18 in the sample delivery line 17, the valve 23 in the carrier gas delivery line 21 and the vacuum pump 28 in the waste line 26 such as to allow for the control of the flow rates of the gaseous sample and the carrier gas to the respective ones of the inlet ports 6, 12 of the first and second channels 4, 10 and the pressure at the outlet port 14 of the second channel 10. The function of the control unit 30 will become clear from the following description of the operation of the sampling system.

In operation, a continuous flow of a gaseous sample is maintained to the inlet port 6 of the first channel 4. In maintaining a continuous flow through the chip 2, the sampling system finds particular application in continuous gas monitoring.

In a standby or non-sampling mode, the flow of the gaseous sample is directed entirely to waste through the outlet port 14 of the second channel 10 as illustrated in FIG. 2(a). In this embodiment the flow of the gaseous sample to waste is achieved both by controlling the vacuum pump 28 such as to maintain a reduced pressure at the outlet port 14 of the second channel 10 as compared to the pressure at the outlet port 8 of the first channel 4 and controlling the valves 18, 23 in the delivery lines 17, 21 such as to maintain the carrier gas at a higher pressure than the gaseous sample. The flow of the gaseous sample is caused to be diverted into the downstream section of the second channel 10 by the combination of the effect of the reduced pressure in the downstream section of the second channel 10 relative to that in the downstream section of the first channel 4 and the action of the flow of the higher-pressure carrier gas which flows orthogonally to the flow of the lower-pressure gaseous sample in the first channel 4. In this embodiment the pressure of the delivered carrier gas is such as to maintain, in addition to a flow through the downstream section of the second channel 10, a flow through the downstream section of the first channel 4. This flow of carrier gas through the downstream section of the first channel 4 is particularly advantageous in that the communication path to the separation column is continuously flushed, thereby preventing the possible situation of sample molecules diffusing from the flow of the gaseous sample into the gaseous environment in communication with the separation column.

In a sample plug injection mode, the valve 23 in the carrier gas delivery line 21 is, under the control of the control unit 30, closed for a predetermined period of time. While the valve 23 in the carrier gas delivery line 21 is closed, the gaseous sample continues as previously to flow through the downstream section of the second channel 10, but also now flows into the downstream section of the first channel 4; flow into the upstream section of the second channel 10 being prevented by the back pressure of the carrier gas remaining therein. This flow into the downstream section of the first channel 4 is illustrated in FIG. 2(b). On opening the valve 23 in the carrier gas delivery line 21, a small plug of the gaseous sample is separated from the main flow of the gaseous sample by the knife-like action of the higher-pressure carrier gas flow. This separation of a sample plug is illustrated in FIG. 2(c). The volume of the sample plug is determined by the dimensions of the channels 4, 10, the injection period and the flow rates of the gaseous sample and the carrier gas. This separated sample plug is then driven by the flow of the carrier gas through the downstream section of the first channel 4 to the separation column.

FIG. 3 illustrates a sampling system in accordance with a second embodiment of the present invention.

The sampling system comprises a microfabricated substrate chip 102 which includes a first channel 104, in this embodiment a linear channel, which includes first and second ports 106, 108, a second channel 110, in this embodiment a linear channel, which intersects the first channel 104 and includes first and second ports 112, 114, and a third channel 115 which includes a port 116 and is connected to the second channel 110 at a point between the point of intersection of the first and second channels 104, 110 and the second port 114 of the second channel 110. In an alternative embodiment the first and second channels 104, 110 can be meandering channels which include a plurality of bends. Preferably, the first, second and third channels 104, 110, 115 each have a width of from about 50 to 300 μm and a depth of from about 10 to 40 μm.

In the same manner as the above-described first embodiment, the chip 102 is fabricated from two plates which are composed of microsheet glass. In a first step, one of the plates is etched by HF wet etching to form wells which define the first, second and third channels 104, 110, 115, with the wells having the dimensions mentioned above. In a second step, four holes are drilled, in this embodiment by ultrasonic vibration, into the other plate so as to provide the ports 106, 108 of the first channel 104, the ports 112, 114 of the second channel 110 and the port 116 of the third channel 115. In a third and final step, the two plates are bonded together by direct fusion bonding.

The sampling system further comprises a sample delivery line 117 which includes a metering valve 118 and is connected to the first port 106 of the first channel 104, in this embodiment by a Swagelok™ connector to a fused silica capillary tube bonded to the chip 102, through which a controlled flow of a gaseous sample is in use introduced.

The sampling system further comprises a sample plug supply line 119 which is connected to the second port 114 of the second channel 110, in this embodiment by a Swagelok™ connector to a fused silica capillary tube bonded to the chip 102, through which a metered volume of the gaseous sample, as a sample plug, is in use fed to the separation column of a measurement system.

The sampling system further comprises a carrier gas supply unit which comprises a carrier gas supply 120, in this embodiment a pressurised gas source, and first and second carrier gas delivery lines 121, 122 which each include a metering valve 123, 124 and connect the carrier gas supply 120 to respective ones of the first port 112 of the second channel 110 and the port 116 of the third channel 115, in this embodiment by Swagelok™ connectors to fused silica capillary tubes bonded to the chip 102, through which separate controlled flows of the carrier gas are in use delivered. In this embodiment the carrier gas is an inert gas such as helium.

The sampling system further comprises a waste line 126 which includes a vacuum pump 128 and is connected to the second port 108 of the first channel 104, in this embodiment by a Swagelok™ connector to a fused silica capillary tube bonded to the chip 102, through which flows of the gaseous sample and the carrier gas are selectively fed from the chip 102. In this embodiment the vacuum pump 28 is provided to maintain a reduced pressure in the downstream section of the first channel 104.

The sampling system further comprises a control unit 130 which is connected to the valve 118 in the sample delivery line 117, the valves 123, 124 in the carrier gas delivery lines 121, 122 and the vacuum pump 128 in the waste line 126 such as to allow for the control of the flow rates of the gaseous sample and the carrier gas to the respective ones of the inlet ports 106, 112, 116 of the first, second and third channels 104, 110, 115 and the pressure at the outlet port 108 of the first channel 104. The function of the control unit 130 will become clear from the following description of the operation of the sampling system.

Operation of the sampling system for batch sampling is as follows.

In a first step, under the control of the control unit 130, the valves 123, 124 in the carrier gas delivery lines 121, 122 are configured such that a relatively low flow of carrier gas is delivered therethrough so as to maintain a flow of carrier gas through each of the sections of the second channel 110 towards the intersection thereof with the first channel 104, the valve 118 in the sample delivery line 117 is configured to provide a flow of a gaseous sample through the first channel 104, and the vacuum pump 128 is configured to provide a reduced pressure at the outlet port 108 of the first channel 104. With this configuration, as illustrated in FIG. 4(a), the flow of the gaseous sample is entirely through the first channel 104, with the carrier gas flows preventing the flow of the gaseous sample into either of the sections of the second channel 110. As illustrated in FIG. 4(a), the carrier gas flows are exhausted with the flow of the gaseous sample to waste, in part sheathing the flow of the gaseous sample. The flow of carrier gas through the downstream section of the second channel 110 is particularly advantageous in that the downstream section of the second channel 110 which is connected to the separation column is continuously flushed, thereby preventing the possible situation of sample molecules diffusing from the flow of the gaseous sample into the gaseous environment in communication with the separation column.

In a second, sample plug injection step, under the control of the control unit 130, the valve 123 in the first carrier gas delivery line 121 is configured such that a relatively high flow of the carrier gas is delivered therethrough, with the relatively low flow of the carrier gas being maintained through the second carrier gas delivery line 122. This high flow of carrier gas separates the plug of the gaseous sample at the intersection of the first and second channels 104, 110, and drives that separated sample plug through the downstream section of the second channel 110 to the separation column, and at the same time flows into the sections of the first channel 104 so as to prevent the introduction of any further of the gaseous sample. This separation and flow into the downstream section of the second channel 110 is illustrated in FIG. 4(b). The volume of the sample plug is determined by the dimensions of the first and second channels 104, 110 and the relative pressures of the carrier gas flows which act to consain and thus squeeze the flow of the gaseous sample at the intersection of the first and second channels 104, 110.

FIG. 5 illustrates a sampling system in accordance with a third embodiment of the present invention.

This sampling system is almost identical to that of the above-described second embodiment, and thus in order to avoid unnecessary duplication of description only the differences will be described in detail, with like parts being designated by like reference signs. This sampling system differs only in that the first channel 104 is non-linear and includes first and second sections 104a, 104b connected to the second channel 110 at spaced points. By spacing the first and second sections 104a, 104b of the first channel 104, the volume of the gaseous sample in the second channel 110, which defines the sample plug, is greater as compared to that in the second-described embodiment where the first channel 104 is a linear channel. As will be understood, the volume of the sample plug can be increased by increasing the spacing or offset of the first and second sections 104a, 104b of the first channel 104. Operation of this sampling system is the same as for the second-described embodiment.

FIG. 6 illustrates a further example sampling system similar to that of FIG. 5.

FIG. 7 illustrates the variation of observed spectral data at a sample output of the system of FIG. 6 demonstrating the sampling operation.

Finally, it will be understood that the present invention has been described in its preferred embodiments and can be modified in many different ways without departing from the scope of the invention as defined by the appended claims.

For example, although the preferred embodiments are based on microfabricated substrate chips 2, 102, these substrate chips could be replaced by large scale components as fabricated from tubing or machined components.

1. A sampling system for separating a volume, as a sample plug, from a flow of a gaseous sample, comprising:
a first flow channel;
a second flow channel intersecting the first flow channel;
a first port in the first flow channel on one side of the point of intersection of the first and second flow channels through which a flow of a gaseous sample is in use delivered;
a second port in the second flow channel on one side of the point of intersection of the first and second flow channels through which a flow of a carrier gas is in use delivered;
a third port in one of the first and second flow channels on the other side of the point of intersection of the first and second flow channels through which a volume, as a sample plug, separated from the gaseous sample flow is in use driven;
a fourth port in the other of the first and second flow channels on the other side of the point of intersection of the first and second flow channels to which a principal flow of the gaseous sample is in use directed; and
a control unit operably configured to control the flow of the carrier gas delivered to the second port such as to separate a volume, as a sample plug, from the gaseous sample flow.

2. The sampling system of claim 1, wherein the third port is in the first flow channel and the fourth port is in the second flow channel, and the control unit is configured to interrupt the flow of the carrier gas to the second port to separate a volume, as a sample plug, from the gaseous sample flow.

3. The sampling system of claim 2, wherein the control unit is configured to interrupt the flow of the carrier gas to the second port for a predetermined period of time, with the period of interruption determining the volume of the separated sample plug.

4. The sampling system of claim 1, wherein the third port is in the second flow channel and the fourth port is in the first flow channel, and the control unit is configured to deliver a high flow of the carrier gas to the second port to separate a volume, as a sample plug, from the gaseous sample flow.

5. The sampling system of claim 4, further comprising a fifth port in the second flow channel on the other side of the point of intersection of the first and second flow channels through which a further flow of the carrier gas is in use delivered, wherein the control unit is configured in a first state to deliver the first and further flows of the carrier gas through the respective ones of the second and fifth ports and in a second, sampling state to deliver a high flow of the carrier gas to the second port to separate a volume, as a sample plug, from the gaseous sample flow.

6. The sampling system of any of claims 1 to 5, wherein the first and second flow channels intersect one another substantially orthogonally.

7. The sampling system of any of claims 1 to 6, wherein the first flow channel includes first and second sections connected at a single point along the length of the second flow channel.

8. The sampling system of any of claims 1 to 6, wherein the first flow channel includes first and second sections connected at respective ones of spaced points along the length of the second flow channel.

9. The sampling system of any of claims 1 to 8, wherein the sampling system further comprises a substrate chip in which the flow channels and the ports are defined.

10. A measurement system incorporating the sampling system of any of claims 1 to 9.

11. A method of separating a volume, as a sample plug, from a flow of a gaseous sample, comprising the steps of:
providing a sampling system comprising a first flow channel, a second flow channel intersecting the first flow channel, a first port in the first flow channel on one side of the point of intersection of the first and second flow channels, a second port in the second flow channel on one side of the point of intersection of the first and second flow channels, a third port in one of the first and second flow channels on the other side of the point of intersection of the first and second flow channels, and a fourth port in the other of the first and second flow channels on the other side of the point of intersection of the first and second flow channels;
flowing a gaseous sample from the first port to the fourth port; and
applying a flow of a carrier gas to the second port such as to separate a volume, as a sample plug, from the gaseous sample flow and drive the separated sample plug to the third port.

12. The method of claim 11, wherein the third port is in the first flow channel and the fourth port is in the second flow channel, and a flow of the carrier gas to the second port is interrupted to separate a volume, as a sample plug, from the gaseous sample flow.

13. The method of claim 12, wherein the flow of the carrier gas is interrupted for a predetermined period of time, with the period of interruption determining the volume of the sample plug.

14. The method of claim 11, wherein the third port is in the second flow channel and the fourth port is in the first flow channel, and a high flow of the carrier gas is delivered to the second port to separate a volume, as a sample plug, from the gaseous sample flow.

15. The method of claim 14, wherein the sampling system further comprises a fifth port in the second flow channel on the other side of the point of intersection of the first and second flow channels, and further comprising the step of applying a flow of the carrier gas to the fifth port, first and further substantially similar flows of the carrier gas being delivered in a first state through the respective ones of the second and fifth ports and in a second, sampling state a high flow of the carrier gas being delivered to the second port to separate a volume, as a sample plug, from the gaseous sample flow.

16. The method of any of claims 11 to 15, wherein the first and second flow channels intersect one another substantially orthogonally.

17. The method of any of claims 11 to 16, wherein the first flow channel includes first and second sections connected at a single point along the length of the second flow channel.

18. The method of any of claims 11 to 16, wherein the first flow channel includes first and second sections connected at respective ones of spaced points along the length of the second flow channel.

19. The method of any of claims 11 to 18, wherein the sampling system further comprises a substrate chip in which the flow channels and the ports are defined.

20. The method of any of claims 11 to 19, wherein the carrier gas is an inert gas.

21. A sampling system for separating a volume, as a sample plug, from a flow of a gaseous sample substantially as hereinbefore described with reference to FIGS. 1 and 2, FIGS. 3 and 4 and/or FIG. 5 of the accompanying drawings.

22. A method of separating a volume, as a sample plug, from a flow of a gaseous sample substantially as hereinbefore described with reference to FIGS. 1 and 2, FIGS. 3 and 4 and/or FIG. 5 of the accompanying drawings.
